(19) United States
(12) Patent Application Publication
(10) Pub. No.: US 2013/0265322 A1
(43) Pub. Date: Oct. 10, 2013

(54) IMAGE PROCESSING APPARATUS, IMAGE PROCESSING SYSTEM, IMAGE PROCESSING METHOD, AND IMAGE PROCESSING PROGRAM

(71) Applicant: CANON KABUSHIKI KAISHA, Tokyo (JP)

(72) Inventors: Takuya Tsujimoto, Kawasaki-shi (JP); Toshiki Shiga, Yokohama-shi (JP); Hidetoshi Tsuzuki, Yokohama-shi (JP)

(21) Appl. No.: 13/909,918

(22) Filed: Jun. 4, 2013

Related U.S. Application Data
(63) Continuation of application No. PCT/JP2012/083825, filed on Dec. 27, 2012.

(30) Foreign Application Priority Data
Dec. 27, 2011 (JP) 2011-286784
Dec. 26, 2012 (JP) 2012-282783

(51) Int. Cl. G09G 5/14

(52) U.S. Cl. CPC G09G 5/14
USPC 345/589; 345/635

(57) ABSTRACT

An image processing apparatus processes a virtual slide image. The image processing apparatus includes a display image data generating unit that performs image processing on at least one of observation region display image data and non-observation region display image data to generate display image data for displaying an image on a display apparatus, the image being different from that obtained when uniform image processing is performed on the entire image data.

### CROSS-REFERENCE TO RELATED APPLICATIONS

This application is a Continuation of International Patent Application No. PCT/JP2012/083825, filed Dec. 27, 2012, which claims the benefit of Japanese Patent Application No. 2011-286784, filed Dec. 27, 2011 and Japanese Patent Application No. 2012-282783, filed Dec. 26, 2012, all of which are hereby incorporated by reference herein in their entirety.

### TECHNICAL FIELD

The present invention relates to an image processing apparatus, an image processing method, an image processing system, and a program.

### BACKGROUND ART

In recent years, in the field of pathology, virtual slide systems have attracted attention as an alternative to optical microscopes serving as a tool for pathological diagnosis. A virtual slide system picks up and digitizes an image of a test sample (specimen) on a prepared slide to allow pathological diagnosis on a display. By digitizing pathological diagnostic images through the use of such a virtual slide system, conventional optical microscope images of test samples can be treated as digital data. This is expected to provide advantages, such as faster remote diagnosis, explanation to patients using digital images, sharing of rare case information, and more efficient teaching and training.

For a virtual slide system to realize an operation comparable to that of an optical microscope, it is necessary to digitize an image of the entire test sample on a prepared slide. By digitizing the image of the entire test sample, the digital data generated by the virtual slide system can be observed through viewer software running on a personal computer (PC) or a workstation. Typically, the number of pixels obtained by digitizing an image of the entire test sample is several hundred millions to several billions, which is a very large amount of data. Although the amount of data generated by the virtual slide system is very large, this allows observation of images, ranging from microscopic images (detailed enlarged images) to macroscopic images (overhead images), through zoom-in and zoom-out operations in the viewer, and provides various convenience. By acquiring all necessary information in advance, images ranging from low-magnification images to high-magnification images can be immediately displayed at a resolution or magnification that the user wishes.

A microscope has been proposed so far in which, in the simultaneous observation of a sample image and an information image through the microscope, the information image can be presented in an easily viewable manner by controlling the amount of light for displaying the information image (Patent Literature (PTL) 1).

### CITATION LIST

### Patent Literature

PTL 1 Japanese Patent Laid-Open No. 8-122647

A virtual slide image, which is displayed on a display by performing image processing on image data obtained by picking up an image of an observation object, is viewed differently from an image observed through a microscope. When a virtual slide image is displayed, the displayed region is often wider than an observation field observed through a microscope. Therefore, a display image (hereinafter also referred to as an “image for display”) that is based on virtual slide image data and displayed on the display contains much information. As a result, an observer has to pay attention to a wide area, and this may be a burden to the observer.

An object of the present invention is to propose an image processing apparatus for generating a virtual slide image that reduces a burden on an observer.

### SUMMARY OF INVENTION

To achieve the object, an aspect of the present invention provides an image processing apparatus that processes a virtual slide image, the image processing apparatus including an image data acquiring unit configured to acquire image data obtained by picking up an image of an imaging target; and a display image data generating unit configured to generate display image data from the image data, the display image data including observation region display image data and non-observation region display image data, the observation region display image data being data for displaying on a display apparatus an observation region determined on the basis of a predetermined technique or specified by a user, the non-observation region display image data being data for displaying on the display apparatus a region outside the observation region. The display image data generating unit performs image processing on at least one of the observation region display image data and the non-observation region display image data to generate the display image data for displaying an image on the display apparatus, the image being different from that obtained when uniform image processing is performed on the entire image data.

Another aspect of the present invention provides an image processing method for processing a virtual slide image, the image processing method including an image data acquiring step of acquiring image data obtained by picking up an image of an imaging target; and a display image data generating step of generating display image data from the image data acquired in the image data acquiring step, the display image data including observation region display image data and non-observation region display image data, the observation region display image data being data for displaying on a display apparatus an observation region determined on the basis of a predetermined technique or specified by a user, the non-observation region display image data being data for displaying on the display apparatus a region outside the observation region. The display image data generating step is a step of performing image processing on at least one of the observation region display image data and the non-observation region display image data to generate the display image data for displaying an image on the display apparatus, the image being different from that obtained when uniform image processing is performed on the entire image data.

Another aspect of the present invention provides an image processing method for processing a virtual slide image, the image processing method including an image data acquiring step of acquiring image data obtained by picking up an image of an imaging target; and a display image data generating step of generating display image data from the image data acquired in the image data acquiring step, the display image data including observation region display image data and non-observation region display image data, the observation region display image data being data for displaying on a display apparatus an observation region determined on the basis of a predetermined technique or specified by a user, the non-observation region display image data being data for displaying on the display apparatus a region outside the observation region. The display image data generating step is a step of performing image processing on at least one of the observation region display image data and the non-observation region display image data to generate first display image data and second display image data, the first display image data being data for displaying on the display apparatus an image different from that obtained when uniform image processing is performed on the entire image data, the second display image data being data obtained when no image processing is performed on the image data or when uniform image processing is performed on the entire image data. The image processing method further includes a display image data transmitting step of transmitting the first display image data to the display apparatus while a position or a display magnification of an image to be displayed on the display apparatus is being changed, and transmitting the second display image data to the display apparatus while a position or a display magnification of an image to be displayed on the display apparatus is not being changed.

Another aspect of the present invention provides an image processing system including the image processing apparatus and a display apparatus. The display apparatus is configured to display a virtual slide image processed by the image processing apparatus in a mode having an observation region that reproduces a microscope field.

Another aspect of the present invention provides a program causing a computer to execute each step of the image processing method.

Further features of the present invention will become apparent from the following description of exemplary embodiments with reference to the attached drawings.

### BRIEF DESCRIPTION OF DRAWINGS

FIG. 1 is a schematic overall view illustrating an apparatus configuration of an image processing system using an image processing apparatus according to the present invention.

FIG. 2 is a functional block diagram illustrating a functional configuration of an image pickup apparatus in the image processing system using the image processing apparatus according to the present invention.

FIG. 3 is a functional block diagram illustrating a functional configuration of the image processing apparatus according to the present invention.

FIG. 4 is a block diagram illustrating a hardware configuration of the image processing apparatus according to the present invention.

FIGS. 5A to 5D are schematic diagrams for explaining a concept of microscope field display (circular display).

FIG. 6 is a flowchart illustrating a flow of microscope field display processing of the image processing apparatus according to the present invention.

FIG. 7 is a flowchart illustrating a detailed flow of generation of microscope field (observation region) display image data in the image processing apparatus according to the present invention.

FIGS. 8A to 8E schematically illustrate examples of a display screen of the image processing system according to the present invention.

FIG. 9 is a schematic overall view illustrating an apparatus configuration of an image processing system using an image processing apparatus according to a second embodiment.

FIG. 10 is a flowchart illustrating a detailed flow of generation of microscope field display image data in the image processing apparatus according to the second embodiment.

### DESCRIPTION OF EMBODIMENTS

Embodiments of the present invention will now be described with reference to the drawings.

An image processing apparatus according to the present invention is an apparatus that processes a virtual slide image. The image processing apparatus includes an image data acquiring unit and a display image data generating unit.

From image data acquired by the image data acquiring unit, the display image data generating unit generates display image data for display on a display apparatus, the display image data including observation region display image data and non-observation region display image data. The observation region is determined on the basis of a predetermined technique, for example, on the basis of information stored in advance in the image processing apparatus or an external storage device and/or on the basis of a user's instruction. The observation region is preferably a reproduction of a microscope field (which is typically circular). The type of microscope field to be reproduced is preferably stored in advance as the information described above. The information stored in advance preferably includes initial field information (which is information selected as an observation region when there is no user's instruction, and is hereinafter also referred to as “initial information”) and/or a plurality of pieces of specific existing microscope field information (i.e., a plurality of pieces of user-selectable microscope field information). The initial field information may be stored to be selected as one of the plurality of pieces of microscope field information. A new observation region determined on the basis of a user's instruction may be stored as additional field information such that it can be selected as an option of field information. A new observation region determined on the basis of a user's instruction may be managed for each user.

The display image data generating unit performs image processing on at least one of the observation region display image data and the non-observation region display image data to generate the display image data for displaying an image on the display apparatus, the image being different from that obtained when uniform image processing is performed on the entire image data.

The display image data generating unit preferably generates the display image data for displaying an observation region that reproduces a microscope field. The display image data generating unit preferably generates the display image data on the basis of existing microscope field information. In this case, the display image data generating unit preferably generates the display image data on the basis of the existing microscope field information and magnification information to be displayed as an image. The display image data generating unit preferably generates the display image data by using a predetermined one of a plurality of pieces of existing microscope field information as initial information. The display image data generating unit preferably generates the display image data by using one of a plurality of pieces of existing microscope field information on the basis of a user's selection. The display image data generating unit preferably generates the display image data such that a brightness of the non-observation region is lower than a brightness of the observation region.

The display image data may be generated by multiplying the image data by multivalued mask information for each pixel. The display image data may be generated by performing computing on the image data on the basis of mask information indicating two processing forms. The mask information indicating two processing forms may represent a position at which the image data is to be adopted and a position at which the image data is to be subjected to bit shifting. Here, the term “position” refers to a display position of the image displayed on the display apparatus. The position may be expressed by including coordinate information in the mask information. The amount of bit shifting may be changed by an instruction externally input. When color image data having RGB color information is used as the image data, the display image data generating unit may convert the image data to brightness color difference data, and perform the computing on a brightness value obtained by the conversion.

When the display image data generating unit generates the display image data for displaying a circular observation region that simulates a microscope field, the amount of bit shifting is preferably changed in accordance with a distance from the center of the circular observation region.

While a position or a display magnification of an image to be displayed on the display apparatus is being changed, the display image data generating unit may generate display image data that does not distinguish the observation region from the non-observation region.

The non-observation region display image data may contain information about the imaging target.

A preferred image processing system of the present invention includes an image processing apparatus and an image display apparatus. In the following description and the attached drawings, “image display apparatus” may be referred to as “display apparatus”. The image processing apparatus described above may be used as the image processing apparatus in the image processing system. The image processing system of the present invention may include an image pickup apparatus and/or an image server described below.

A preferred image processing method of the present invention is an image processing method for processing a virtual slide image, and includes at least an image data acquiring step and a display image data generating step. The image processing method of the present invention may further include a display image data transmitting step after the display image data generating step. The image data acquiring step acquires image data obtained by picking up an image of an imaging target. The display image data generating step generates display image data including observation region display image data and non-observation region display image data. The display image data is data for displaying an image on a display apparatus. Embodiments described above or below for the image processing apparatus may be reflected in the image processing method of the present invention.

The display image data generating step according to a preferred embodiment of the present invention generates first display image data that includes observation region display image data and non-observation region display image data and/or second display image data that does not distinguish the observation region display image data from the non-observation region display image data. The second display image data is obtained when no image processing is performed on the image data or when uniform image processing is performed on the entire image data.

The display image data transmitting step according to a preferred embodiment of the present invention transmits the first display image data to the display apparatus while a position or a display magnification of an image to be displayed on the display apparatus is being changed. Also, the display image data transmitting step according to the preferred embodiment of the present invention transmits the second display image data to the display apparatus while a position or a display magnification of an image to be displayed on the display apparatus is not being changed.

A program according to the present invention is a program that causes a computer to execute each step of the image processing method described above.

The present invention will now be described with reference to the following embodiments.

### First Embodiment

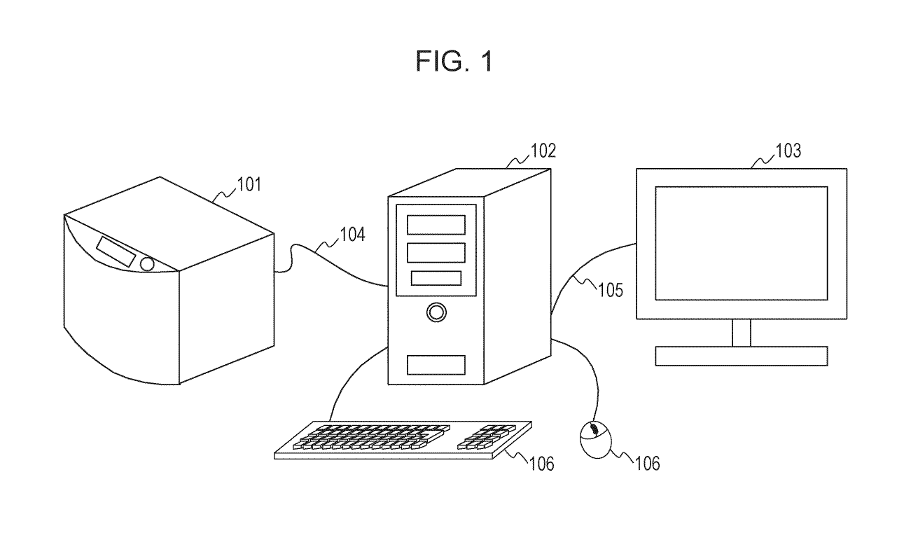

An image processing apparatus according to the present invention can be used in an image processing system that includes an image pickup apparatus and a display apparatus. The image processing system will now be described with reference to FIG. 1.

### (Apparatus Configuration of Image Processing System)

FIG. 1 is a schematic overall view of an image processing system using an image processing apparatus according to the present invention. The image processing system includes an image pickup apparatus (e.g., a microscope apparatus or a virtual slide scanner) 101, an image processing apparatus 102, and an image display apparatus 103. The image processing system is a system that has the function of acquiring and displaying a two-dimensional image of a specimen (test sample), which is an imaging target subjected to image pickup. In the present embodiment, the image pickup apparatus 101 and the image processing apparatus 102 are connected to each other by a special-purpose or general-purpose I/F cable 104, and the image processing apparatus 102 and the image display apparatus 103 are connected to each other by a general-purpose I/F cable 105.

A virtual slide apparatus can be suitably used as the image pickup apparatus 101. The virtual slide apparatus has the function of picking up a single two-dimensional image or a plurality of two-dimensional images that differ in position in the two-dimensional plane direction, and outputting a digital image. A solid-state image pickup device, such as a charge coupled device (CCD) sensor or a complementary metal oxide semiconductor (CMOS), is suitably used to acquire two-dimensional images. Instead of the virtual slide apparatus, a digital microscope apparatus may be used as the image pickup apparatus 101. The digital microscope apparatus is obtained by attaching a digital camera to an eyepiece of a typical optical microscope. Even when an image is picked up by a digital camera, the resultant image can be divided into an observation region and a non-observation region if a high-magnification display mode is selected or if display image data is formed by combining original image data obtained by picking up an image multiple times by varying the image pickup region.

An apparatus having the function of generating data for display on the display apparatus 103, from one or more pieces of original image data acquired from the image pickup apparatus 101, in accordance with a user's request can be suitably used as the image processing apparatus 102. For example, the image processing apparatus 102 may be a general-purpose computer or workstation that includes hardware resources, such as a central processing unit (CPU), a RAM, a storage device, and various I/Fs including an operation unit. A large-capacity information storage device, such as a hard disk drive, can be suitably used as the storage device. The storage device preferably stores programs and data for realizing each processing (described below) and an operating system (OS). Each of the functions described above is realized when the CPU loads a necessary program and data from the storage device into the RAM and executes the program. An operation unit 106 includes, for example, a keyboard and a mouse. An operator uses the operation unit 106 to input various instructions. The operation unit 106 may be a component of the image processing apparatus 102.

The image display apparatus 103 of the present embodiment is a display that displays an observation image obtained as a result of computing in the image processing apparatus 102. The display apparatus 103 may include a CRT or a liquid crystal display.

In the example illustrated in FIG. 1, the image processing system includes three apparatuses, the image pickup apparatus 101, the image processing apparatus 102, and the image display apparatus 103. However, the configuration of the present invention is not limited to this. For example, an image processing apparatus integral with an image display apparatus may be used, or functions of the image processing apparatus may be incorporated into an image pickup apparatus. The functions of the image pickup apparatus, image processing apparatus, and image display apparatus may be realized by a single apparatus. Conversely, the functions of the image processing apparatus or the like may be divided and realized by a plurality of different apparatuses.

### (Functional Configuration of Image Pickup Apparatus)

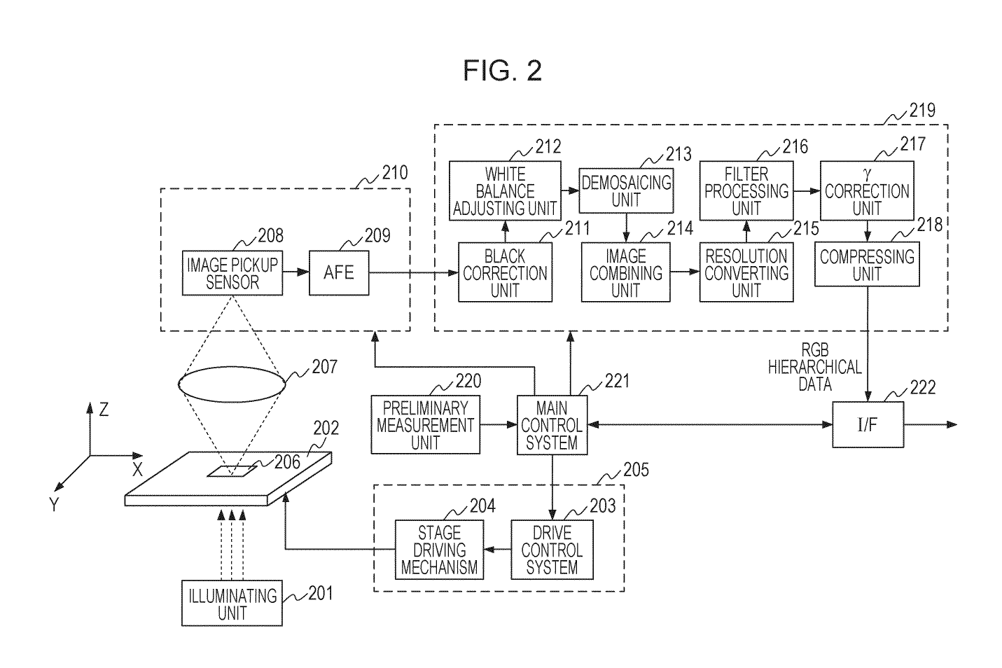

FIG. 2 is a functional block diagram illustrating a functional configuration of the image pickup apparatus 101.

The image pickup apparatus 101 of the present embodiment mainly includes an illuminating unit 201, a stage 202, a stage control unit 205, an imaging optical system 207, an image pickup unit 210, a developing unit 219, a preliminary measurement unit 220, a main control system 221, and a data output unit (I/F) 222.

The illuminating unit 201 of the present embodiment is a means for uniformly illuminating a prepared slide 206 on the stage 202. Preferably, the illuminating unit 201 includes a light source, an illumination optical system, and a control system for driving the light source. The stage 202 of the present embodiment is drive-controlled by the stage control unit 205 and is movable in three (XYZ) axial directions. The prepared slide 206 of the present embodiment is obtained by placing a slice of tissue or spread cells on a slide glass and securing the slice of tissue or spread cells under a cover glass with a mounting agent.

The stage control unit 205 of the present embodiment includes a drive control system 203 and a stage driving mechanism 204. In the present embodiment, the drive control system 203 drive-controls the stage 202 in response to an instruction from the main control system 221. In the present embodiment, the direction and amount of movement of the stage 202 is determined on the basis of positional information and thickness information (distance information) of a specimen measured by the preliminary measurement unit 220 and a user's instruction input as required. The stage driving mechanism 204 of the present embodiment drives the stage 202 in accordance with an instruction from the drive control system 203.

The imaging optical system 207 of the present embodiment is a lens group for forming, on an image pickup sensor 208, an optical image of the specimen on the prepared slide 206.

The image pickup unit 210 of the present embodiment includes the image pickup sensor 208 and an analog front end (AFE) 209. The image pickup sensor 208 of the present embodiment is a one-dimensional or two-dimensional image sensor that converts a two-dimensional optical image into an electrical physical quantity by photoelectric conversion. For example, a CCD sensor or a CMOS device is used as the image pickup sensor 208. When a one-dimensional sensor is used as the image pickup sensor 208, a two-dimensional image can be obtained by scanning with the one-dimensional sensor in the scanning direction. The image pickup sensor 208 of the present embodiment outputs an electrical signal having a voltage value corresponding to the intensity of light. When a color image is desired as a picked-up image, a single-plate image sensor having a Bayer-pattern color filter attached thereto can be used as the image pickup sensor. The image pickup unit 210 of the present embodiment can pick up image segments of a specimen image through an image pickup operation by moving the stage 202 in the XY axis direction.

The AFE 209 of the present embodiment is a circuit that converts an analog signal output from the image pickup sensor 208 into a digital signal. The AFE 209 preferably includes an H/V driver, a correlated double sampling (CDS) circuit, an amplifier, an AD converter, and a timing generator. The H/V driver of the present embodiment converts a vertical synchronizing signal and a horizontal synchronizing signal for driving the image pickup sensor 208 into a potential necessary to drive the sensor. The CDS circuit of the present embodiment is a circuit that removes fixed pattern noise. The amplifier of the present embodiment is an analog amplifier that adjusts a gain of an analog signal from which noise has been removed by the CDS circuit. The AD converter of the present embodiment converts an analog signal into a digital signal. When the final stage output of the image pickup apparatus is 8 bits, the AD converter preferably converts an analog signal into digital data which is quantized to about 10 bits to 16 bits in consideration of processing to be done in the subsequent stages, and outputs this digital data. The sensor output data obtained by the conversion is referred to as RAW data. In the present embodiment, the RAW data is developed by the developing unit 219 in the subsequent stage. The timing generator of the present embodiment generates a signal for adjusting the timing of the image pickup sensor 208 and the timing of the developing unit 219 in the subsequent stage.

When a CCD sensor is used as the image pickup sensor 208, the AFE 209 described above is typically used. When a CMOS image sensor capable of digital output is used as the image pickup sensor 208, the functions of the AFE 209 are typically included in the sensor. Although not shown in the drawing, there is an image pickup controller that controls the image pickup sensor 208 in the present embodiment. The image pickup controller controls not only the operation of the image pickup sensor 208, but also controls the operation timing, such as shutter speed and frame rate, and the region of interest (ROI).

The developing unit 219 of the present embodiment includes a black correction unit 211, a white balance adjusting unit 212, a demosaicing unit 213, an image combining unit 214, a resolution converting unit 215, a filter processing unit 216, a γ correction unit 217, and a compressing unit 218. The black correction unit 211 of the present embodiment subtracts black-correction data obtained in a light shielding state from each pixel of the RAW data. The white balance adjusting unit 212 of the present embodiment reproduces a desirable white color by adjusting the gain of each of the RGB colors in accordance with the color temperature of light from the illuminating unit 201. Specifically, data for white balance correction is added to the black-corrected RAW data. The white balance adjustment is not required in handling a monochrome image. The developing unit 219 of the present embodiment generates hierarchical image data (described below) from image segment data of the specimen image picked up by the image pickup unit 210.

The demosaicing unit 213 of the present embodiment generates image data of each of the RGB colors from Bayer-pattern RAW data. The demosaicing unit 213 of the present embodiment calculates a value of each of the RGB colors for a target pixel by interpolating values of neighboring pixels (including pixels of the same color and pixels of other colors) in the RAW data. The demosaicing unit 213 of the present embodiment also performs correction (interpolation) of defective pixels. The demosaicing is not required when the image pickup sensor 208 has no color filter and a monochrome image is obtained.

The image combining unit 214 of the present embodiment pieces together image data acquired, by the image pickup sensor 208, by dividing an image pickup region to generate large-volume image data of a desired image pickup region. Generally, the region where a specimen is present is greater than an image pickup region acquired in a single image pickup operation by an existing image sensor. Therefore, a single piece of two-dimensional image data is generated by piecing together a plurality of pieces of image segment data. For example, assume that an image of a 10-mm square region on the prepared slide 206 is to be picked up with a resolution of 0.25 μm. In this case, the number of pixels per side is 10 mm/0.25 μm=40000, so that the total number of pixels is the square of this value, that is, 1.6 billion pixels. To acquire image data of 1.6 billion pixels using the image pickup sensor 208 having 10 million (10 M) pixels, it is necessary to divide the region into 1.6 billion/10 million=160 segments to perform an image pickup operation. A plurality of pieces of image data are pieced together, for example, by positioning based on the positioning information of the stage 202, by matching the corresponding points or lines of the plurality of image segments, or on the basis of the positional information of image segment data. The plurality of pieces of image data can be smoothly pieced together by interpolation, such as zero-order interpolation, linear interpolation, or high-order interpolation. Although generation of one large-volume image is assumed in the present embodiment, the image processing apparatus 102 may be configured to have the function of piecing together separately acquired image segments during generation of display image data.

To quickly display a large-volume two-dimensional image generated by the image combining unit 214, the resolution converting unit 215 of the present embodiment generates an image in accordance with a display magnification through resolution conversion in advance. The resolution converting unit 215 generates and combines image data of multiple levels, from low to high magnifications, to form image data having a hierarchical structure. It is desirable that image data acquired by the image pickup apparatus 101 be high-resolution image pickup data for diagnostic purposes. However, for displaying a reduced image of image data composed of several billion pixels as described above, the processing may be delayed if resolution conversion is performed in accordance with every display request. Therefore, it is preferable to prepare a hierarchical image of several different magnifications in advance, select image data with a magnification close to a display magnification from the prepared hierarchical image in accordance with a request from the display side, and adjust the magnification to the display magnification. For better image quality, it is preferable to generate display image data from image data with a higher magnification. When an image is picked up at a high resolution, hierarchical image data for display is generated by reducing the image with a resolution conversion technique on the basis of image data with the highest resolving power. The resolution conversion technique applicable here is bilinear interpolation, which is two-dimensional linear interpolation, or bicubic interpolation using a three-dimensional interpolation formula.

The filter processing unit 216 of the present embodiment is a digital filter that suppresses high-frequency components contained in an image, removes noise, and enhances the feeling of resolution. The y correction unit 217 of the present embodiment performs processing to add an inverse characteristic to an image in accordance with gradation expression characteristics of a typical display device, or performs gradation conversion in accordance with human visual characteristics through gradation compression of a high-brightness portion or processing of a dark portion. Since an image is acquired for the purposes of morphological observation in the present embodiment, gradation conversion suitable for image combining or display processing in the subsequent stages is performed on image data.

The compressing unit 218 of the present embodiment performs compression coding for the purposes of improving efficiency in transmission of large-volume two-dimensional image data and reducing the volume of data to be stored. As a method of still image compression, a standardized coding method, such as a Joint Photographic Experts Group (JPEG) method, or an improved and evolved version of the JPEG method, such as a JPEG 2000 or JPEG XR method, can be used here.

The preliminary measurement unit 220 of the present embodiment performs preliminary measurement for calculating positional information of the specimen on the prepared slide 206, information about distance to a desired focal position, and parameters for adjusting the amount of light attributable to the thickness of the specimen. The preliminary measurement unit 220 acquires information before main measurement (i.e., acquisition of picked-up image data) to allow the image pickup operation to be efficiently performed. A two-dimensional image pickup sensor having a resolving power lower than that of the image pickup sensor 208 may be used to acquire positional information for a two-dimensional plane. The preliminary measurement unit 220 identifies the position of the specimen in the XY plane from the acquired image. A laser displacement meter or a Shack-Hartmann-based instrument may be used to acquire distance information and thickness information.

The main control system 221 of the present embodiment controls each of the various units described above. The control operations of the main control system 221 and the developing unit 219 can be realized by a control circuit having a CPU, a ROM, and a RAM. For example, a program and data are stored in the ROM in advance, and the CPU executes the program using the RAM as a work memory. The functions of the main control system 221 and the developing unit 219 are thus realized. The ROM may be such a device as an EEPROM or flush memory. The RAM may be a DRAM device, such as a DDR3. The function of the developing unit 219 may be replaced by an ASIC formed as a dedicated hardware device.

The data output unit 222 of the present embodiment is an interface for transmitting an RGB color image generated by the developing unit 219 to the image processing apparatus 102. The image pickup apparatus 101 and the image processing apparatus 102 of the present embodiment are connected to each other by an optical communication cable. This cable may be replaced by a general-purpose interface, such as a USB or Gigabit Ethernet (registered trademark).

### (Functional Configuration of Image Processing Apparatus)

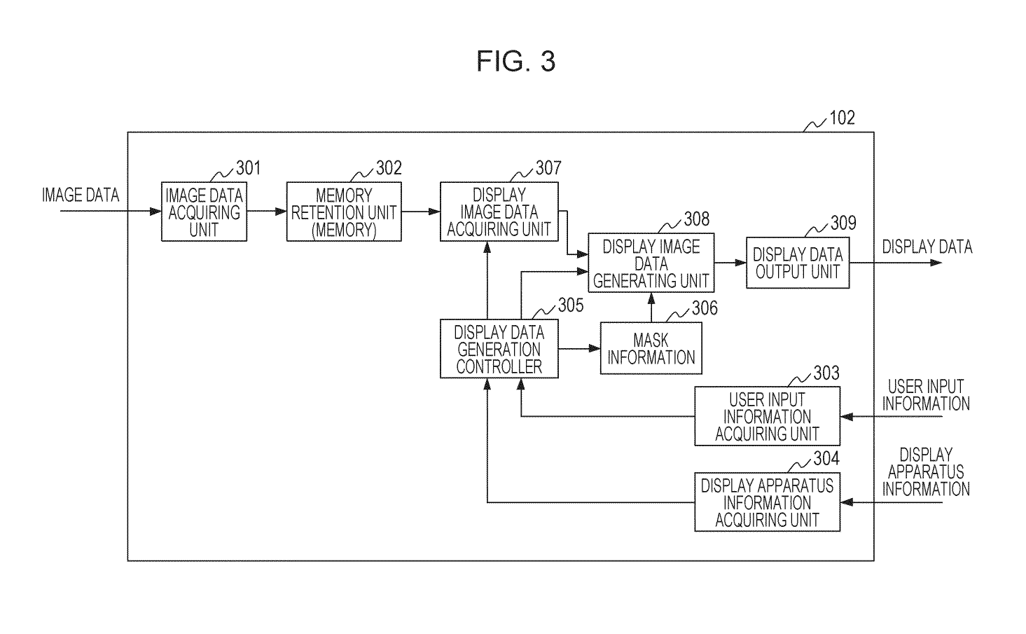

FIG. 3 is a functional block diagram illustrating a functional configuration of the image processing apparatus 102 according to the present invention.

The image processing apparatus 102 of the present embodiment mainly includes an image data acquiring unit 301, a memory retention unit (or memory) 302, a user input information acquiring unit 303, a display apparatus information acquiring unit 304, a display data generation controller 305, mask information 306, a display image data acquiring unit 307, a display image data generating unit 308, and a display data output unit 309. In the following description and the attached drawings, “image data for display (or display image data)” may be referred to as “display data”, and “image for display” may be referred to as “display image”.

The image data acquiring unit 301 of the present embodiment acquires image data of an image picked up by the image pickup apparatus 101. In the present embodiment, the term “image data” refers to at least one of the following: a plurality of pieces of image segment data of RGB colors obtained by picking up an image of a specimen in segments, a piece of two-dimensional image data obtained by combining the plurality of pieces of image segment data, and image data hierarchically organized for each display magnification on the basis of the two-dimensional image data. Note that the image segment data may be monochrome image data.

The memory retention unit 302 of the present embodiment captures and stores image data acquired from an external apparatus via the image data acquiring unit 301. The memory retention unit 302 preferably retains not only a plurality of pieces of specific existing microscope field information, but also information about which of the plurality of pieces of field information is to be initially used.

The user input information acquiring unit 303 of the present embodiment acquires information (user input information) input by the user through the operation unit including the keyboard and the mouse. Examples of the user input information include an instruction to update display image data, such as an instruction to change a display position or an instruction to display an enlarged or reduced image; selection of display mode; and designation of an observation region (e.g., selection of any of the plurality of pieces of microscope field information retained by the memory retention unit). In the present embodiment, the display mode includes a mode for reproducing a display form that simulates a microscope observation field, and a mode for not reproducing it. The amount of bit shifting (described above) can also be specified or changed by the user. Although the microscope field is assumed to be circular in the present embodiment, the shape is not limited to this.

The display apparatus information acquiring unit 304 of the present embodiment acquires not only display area information (screen resolution) of a display included in the display apparatus 103, but also display magnification information of an image currently displayed.

The display data generation controller 305 of the present embodiment controls generation of display image data in accordance with a user's instruction acquired by the user input information acquiring unit 303. Also, the display data generation controller of the present embodiment generates and updates mask information (described below).

The mask information 306 of the present embodiment is control information for generating display image data necessary to reproduce a microscope field on the display screen. The mask information 306 of the present embodiment contains information of display pixels that form a display area of the display apparatus 103. This makes it possible to determine, for each pixel, whether the corresponding image data is to be displayed without changing the brightness value or the brightness value is to be changed. In the present embodiment, if each pixel has a 5-bit value and the mask information is 0, the value of the image data is used as display image data without change, whereas if the mask information is a given value, the brightness value is bit-shifted by this value to the lower-order side. For example, when each pixel has 8-bit (256-gradation) brightness data, if the value of the mask information is 1, the brightness data is reduced by half in value by shifting the brightness data by 1 bit to the left. If the brightness data is shifted by 8 bits, the value of the image data is 0. An 8-bit shift makes the value of image data 0. This means that the display pixel is completely masked (i.e., the brightness value of the target display pixel is 0). In the present embodiment, the brightness value of the non-observation region may be set to 0 or any other value lower than the original brightness value to reduce the brightness. In the present embodiment, brightness data of each pixel is assumed to be the target of computing with the mask information. However, if RGB color image data is assumed to be the target, the RGB color image data may be converted to brightness/color difference signals of YUV or YCC, so that brightness information obtained by the conversion can be used as the target of computing. Alternatively, bit shifting may be applied to each of the RGB colors. The bit shifting may be freely set for the display pixels within the display area. The following description will be made on the assumption that, to reproduce a microscope observation field, the mask value within a circular field is 0 and the mask value for the other region is 2. In the display area for which 2 is set as the mask value, the brightness value of acquired image data is reduced to a quarter. The brightness may be increased by using a configuration in which a meaning is assigned to a specific bit.

The mask information 306 of the present embodiment reflects either the initial field information described above or observation region information specified by the user. Examples of the observation region information specified by the user include information selected by the user from the plurality of pieces of existing microscope field information, information specified by the user by modifying such existing microscope field information, and observation region information specified by the user independently of the microscope field information. The initial field information may be included in advance as part of the mask information 306, or the initial field information retained by the memory retention unit 302 may be read by the display data generation controller 305 from the memory retention unit 302. The observation region information specified by the user can be reflected, through the user input information acquiring unit 303 and the display data generation controller 305, in the mask information.

In accordance with the control of the display data generation controller 305, the display image data acquiring unit 307 of the present embodiment acquires image data necessary for display from the memory retention unit 302.

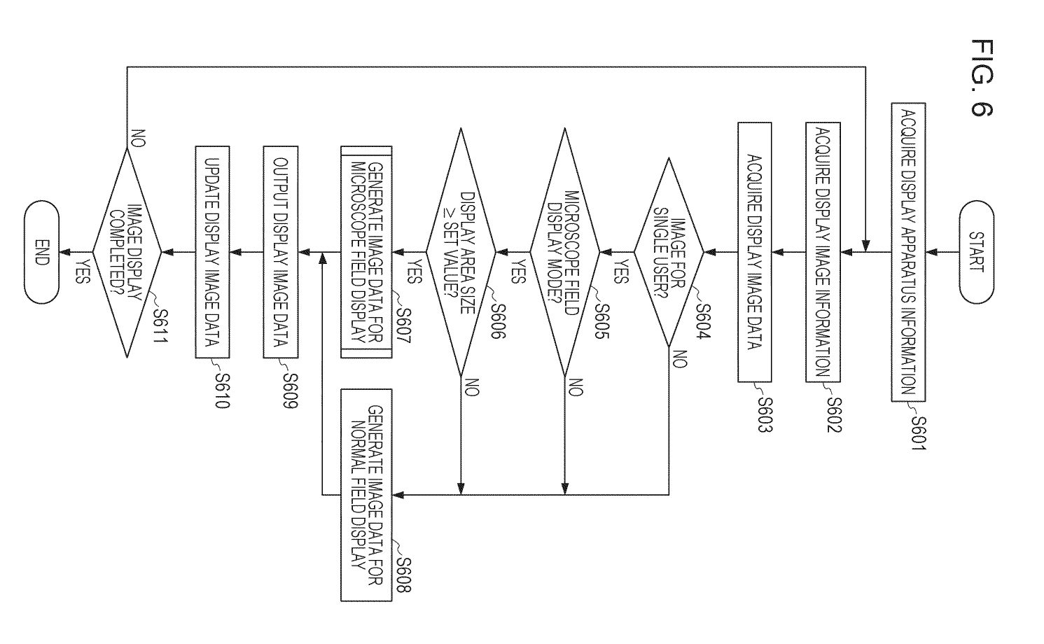

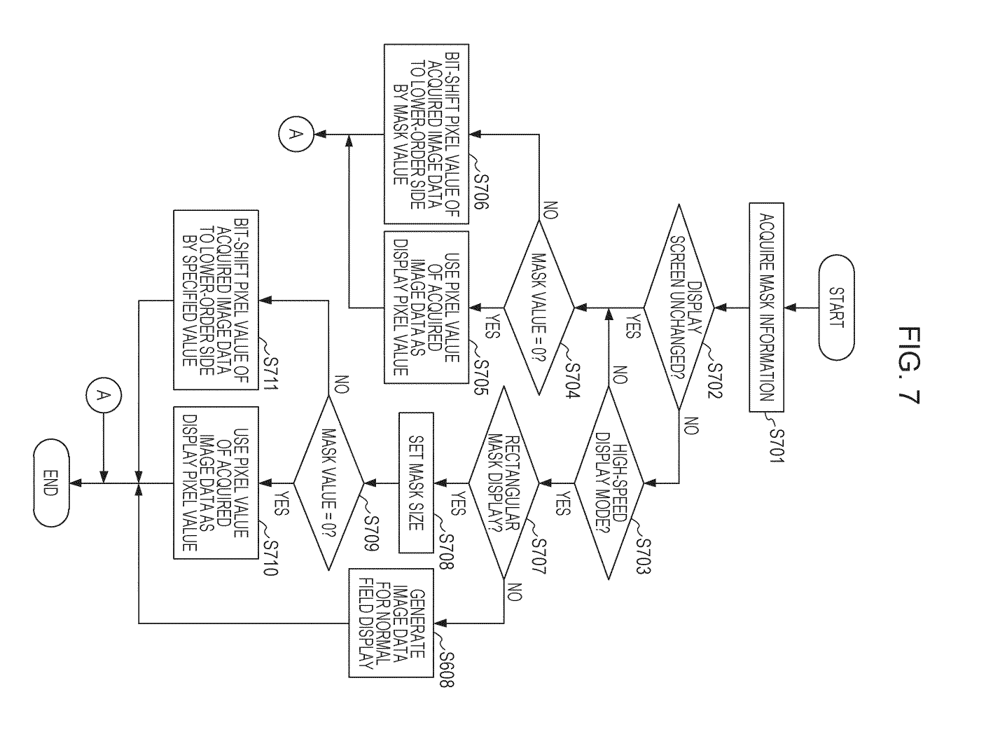

The display image data generating unit 308 of the present embodiment generates display data for display on the display apparatus 103 by using the image data acquired by the display image data acquiring unit 307 and the mask information 306. The generation of the display data will be described in detail below using the flowcharts of FIG. 6 and FIG. 7.

The display data output unit 309 of the present embodiment outputs the display data generated by the display image data generating unit 308 to the display apparatus 103, which is an external apparatus.

### (Hardware Configuration of Image Processing Apparatus)

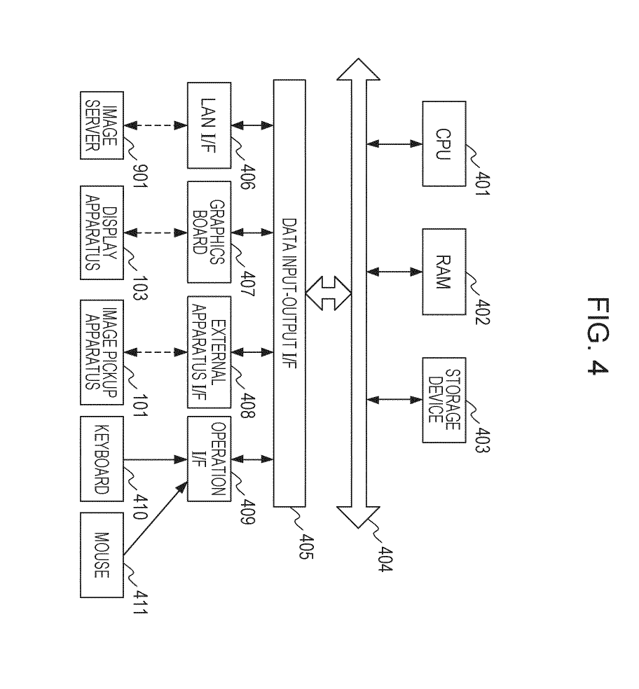

FIG. 4 is a block diagram illustrating a hardware configuration of the image processing apparatus according to the present invention. For example, an information processing apparatus, such as a personal computer (PC), is used as the image processing apparatus.

The PC of the present embodiment includes a central processing unit (CPU) 401, a random access memory (RAM) 402, a storage device 403, a data input-output I/F 405, and an internal bus 404 that connects them to one another.

The CPU 401 of the present embodiment accesses the RAM 402, when necessary, to perform overall control of all blocks of the PC while performing various types of computing. The RAM 402 is used as a work area for the CPU 401. The RAM 402 temporarily stores the OS, various programs in execution, and various types of data (including the plurality of pieces of microscope field information) to be subjected to processing, such as generation of display data that simulates a microscope observation field, which is a feature of the present invention. The storage device 403 of the present embodiment is an auxiliary storage for recording and reading the OS executed by the CPU 401 and information in which firmware, including programs and various parameters, is firmly stored. In the present embodiment, a magnetic disk drive, such as a hard disk drive (HDD), or a semiconductor device using a flash memory, such as a solid state disk (SSD), is used as the storage device 403. The storage device 403 of the present embodiment stores some or all of the OS, various programs in execution, and various types of data (including the plurality of pieces of microscope field information) to be subjected to processing, such as generation of display data that simulates a microscope observation field, which is a feature of the present invention.

The data input-output I/F 405 of the present embodiment is connected via a LAN I/F 406 to an image server, connected via a graphics board to the display apparatus 103, connected via an external apparatus I/F to the image pickup apparatus 101 such as a virtual slide apparatus or a digital microscope, and connected via an operation I/F 409 to a keyboard 410 and a mouse 411.

The display apparatus 103 of the present embodiment is a display device that uses, for example, liquid crystal, electro-luminescence (EL), or cathode ray tube (CRT). Although the display apparatus 103 connected as an external apparatus is assumed to be used here, a PC integral with a display apparatus, such as a notebook PC, may be used as the display apparatus 103.

Although pointing devices, such as the keyboard 410 and the mouse 411, are assumed to be devices connected to the operation I/F 409 of the present embodiment, a screen of the display apparatus 103, such as a touch panel, may be configured to serve as a direct input device. In this case, the touch panel may be integral with the display apparatus 103.

(Concept of Microscope Field display (Circular Display))

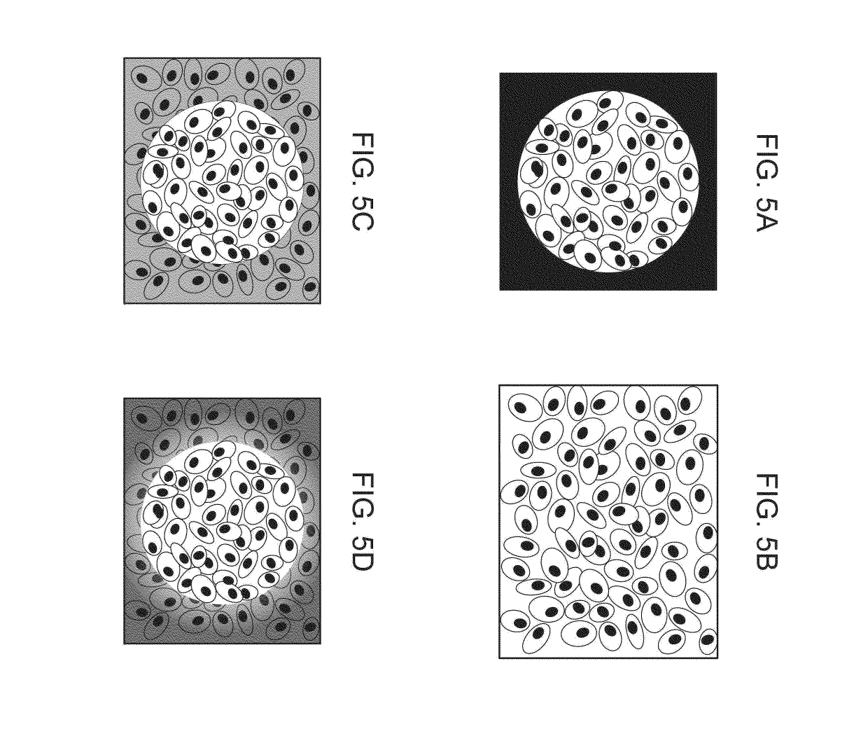

FIGS. 5A to 5D are schematic diagrams for conceptually explaining a microscope field and a display form that reproduces the microscope field.

FIG. 5A illustrates a field observed when the user looks into the microscope. A microscope field is uniquely defined by a magnification of an objective lens and a field number of the microscope. Specifically, a field of view (F.O.V.) of the microscope is expressed as F.O.V.=(field number of eyepiece)/(magnification of objective lens). In the case of an optical microscope, the field of view is expressed as F.O.V.=(field number of eyepiece)/((magnification of objective lens)×(zoom factor)). When looking into the microscope, the user can observe a magnified image of a specimen (object) within a circular region as illustrated in the drawing. The user cannot see the image in an area outside the circular observation region, because light does not reach this area. Before the arrival of virtual slide apparatuses, pathologists (users) used to observe such observation images to make diagnosis. With a digital camera placed at the eyepiece of the optical microscope, it is possible to acquire a digital observation image. In the acquired image data, information is lost in an area outside the circular observation region, as in the case of FIG. 5A.

FIG. 5B illustrates an example where image data acquired by the virtual slide apparatus is presented on the display screen of the display apparatus 103. The image data acquired by the virtual slide apparatus is prepared as an image obtained by piecing together a plurality of pieces of image data corresponding to an image of part of the specimen picked up in segments. Thus, since a wider range of information than the microscope field can be presented over the entire screen of the display apparatus 103, it is possible to provide a variety of convenience. For example, the user does not have to look into the microscope, a certain amount of viewing distance can be ensured, and more image data and information related to the specimen can be presented together.

FIG. 5C illustrates an example where image data acquired by the virtual slide apparatus is displayed on the display apparatus 103 to simulate a microscope field. Although a specimen image is displayed in a wide display area, the brightness of a region outside the microscope observation field to be paid attention to is lowered. Thus, it is possible not only to reproduce the observation field of the microscope with which pathologists are familiar, but also to present more image information in the neighboring region, which is an advantage of the virtual slide apparatus. The amount of information in the region outside the microscope observation field can be reduced not only by lowering the brightness, but also by reducing color information to display this region in monochrome.

Like FIG. 5C, FIG. 5D illustrates an example where a display image that simulates a microscope observation field is presented. The image in the microscope observation field to be paid attention to is presented in the same manner as in FIG. 5C. However, in FIG. 5D, the brightness of the region outside the microscope observation field is lowered in accordance with a distance from the center of the circular region (i.e., from the point of attention). In FIG. 5C, the amount of information is reduced uniformly over the entire region outside the microscope field. In FIG. 5D, however, the amount of information is made larger in the region to be paid attention to and its vicinity. This increases the level of convenience in that, for example, the region of interest can be easily found.

### (Microscope Field Display Processing)

A flow of microscope field display processing in the image processing apparatus of the present invention will now be described with reference to the flowchart of FIG. 6.

In step S601, size information (screen resolution) of the display area of the display, which is the display apparatus 103, is acquired from the display apparatus 103 by the display apparatus information acquiring unit 304. The size information of the display area is used to determine the size of display data to be generated.

In step S602, display magnification information of an image currently displayed on the display apparatus 103 is acquired by the display apparatus information acquiring unit 304. A specified magnification is set in the initial stage. The display magnification is used to select any image data from a hierarchical image.

In step S603, on the basis of the size information of the display area acquired in step S601 and the display magnification information acquired in step S602, image data for display on the display apparatus 103 is acquired from the memory retention unit 302.

In step S604, a determination is made as to whether a displayed image is to be shared by multiple persons. If the display image is not to be shared by multiple persons, in other words, if the display image is to be used by a single user, the processing proceeds to step S605. If the display image is to be shared by multiple persons, the processing proceeds to step S608. Such a display image is shared by multiple persons, for example, in the cases of in-hospital conferences attended by pathologists and others involved such as clinicians, and presentations for the purposes of educating students and doctors in training. When such a display image is shared by multiple persons, an attention region in the presented display image may be different depending on the user. Therefore, it is preferable to select a normal field observation mode, not a microscope observation field mode which may hinder the individual observations.

In step S605, a determination is made as to whether the user has selected the microscope observation field mode. If the microscope observation field mode has been selected, the processing proceeds to step S606. If the normal field observation mode has been selected, the processing proceeds to step S608.

In step S606, a determination is made as to whether the display area information (screen resolution) of the display apparatus 103 acquired in step S601 is greater than or equal to a value set in advance. If the display area information (screen resolution) is greater than or equal to the set value, the processing proceeds to step S607, and if it is less than the set value, the processing proceeds to step S608. If the screen resolution (display area information) of the display apparatus 103 is high, a large amount of information can be displayed. This means that the user has to pay attention to a large area. To reduce the burden on the user, it is preferable to select the microscope observation field mode. Conversely, even when it is determined in step S605 that the user has selected the microscope observation field mode, if the screen resolution of the display apparatus 103 is low, it is preferable to selects the normal field observation mode which allows displayable information to be presented without change. The set value serving as a reference for the determination can be specified by the user. The determinations in step S605 and step S606 may be reversed in order.

In step S607, in response to the selection of the microscope observation field mode, image data for microscope field display is generated. The image data for microscope field display is composed of the observation region display image data and the non-observation region display image data. When image processing is performed on at least one of them, the display apparatus displays an image different from that displayed when uniform image processing is performed on the entire image data. This will be described in detail below with reference to FIG. 7.

In step S608, in response to the selection of the normal observation mode, display image data for normal observation is generated. The image data with a similar display magnification acquired from the hierarchical image in step S603 is subjected to resolution conversion to achieve a desired resolution. As necessary, correction is performed in accordance with the characteristics of the display apparatus 103.

In step S609, the display data generated in step S607 or step S608 is output to the display apparatus 103.

In step S610, the display apparatus 103 displays the input display image data on the screen.

In step S611, a determination is made as to whether the image display operation has been completed. If the user selects another specimen image or closes the display application, the processing ends here. If the updating of the display screen is to be continued, the processing returns to step S602 and the subsequent processing is repeated.

### (Generation of Microscope Field Display Image Data)

FIG. 7 is a flowchart illustrating a detailed flow of generation of display image data for reproducing a microscope field described in step S607 of FIG. 6. Here, the term “microscope field” refers to the observation region described above. The term “non-microscope field” refers to a region outside the observation region here.

In step S701, the mask information 306 is acquired. The mask information 306 contains information of display pixels that form the display area of the display apparatus 103. This makes it possible to determine, for each pixel, whether the corresponding image data is to be displayed without changing the brightness value or the brightness value is to be changed.

In step S702, a determination is made as to whether there is any change to the display screen. If there is no change to the display screen and the state of the currently displayed screen is to be maintained, the processing proceeds to step S704. If the display screen has been updated by screen scrolling or zooming in or out, the processing proceeds to step S703.

In step S703, a determination is made as to whether the current display mode is a high-speed display mode or a normal observation field display mode. The high-speed display mode is a mode for reproducing a microscope observation field. If the display screen is not updated and is at a standstill, a circular microscope observation field is reproduced in the high-speed display mode. If the display screen is being updated by screen scrolling or the like, the circular display is stopped for high-speed processing in the high-speed display mode. Then, a rectangular display area is used to separately present a display image with a normal brightness for close attention, and a display image with a lower brightness for not hindering the close attention. If the high-speed display mode is selected, the processing proceeds to step S707. If the microscope field is to be reproduced, the processing proceeds to step S704 regardless of whether the display screen is updated.

In step S704, for reproduction of the microscope field, a value of the mask information acquired in step S701 is referred to for each of the corresponding pixels. Then, a determination is made as to whether the value of the mask information referred to for the corresponding display pixel is 0, in other words, whether the pixel is to be presented at a normal brightness in the attention region, or is to be presented at a lower brightness in the region outside the microscope observation field. If the mask value is 0, the processing proceeds to step S705. If the mask value is not 0, in other words, if the brightness value of the pixel is to be lowered by bit shifting, the processing proceeds to step S706.

In step S705, since the mask value is 0, the brightness value of the pixel of the acquired image data is used as a pixel value for display without change. The brightness value may be changed if correction is performed in accordance with the characteristics of the display apparatus 103.

In step S706, since the mask value is not 0, the brightness value of the pixel of the acquired image data is bit-shifted to the lower-order side in accordance with the value of the mask information acquired in step S701. Thus, the brightness can be lowered in accordance with the mask value.

In step S707, since the high-speed display mode is selected, a determination is made as to whether the mask (observation field) for high-speed display is to be rectangular in shape and smaller in size than the display region. If a rectangular observation field is to be displayed in a size smaller than that of the display region of the screen, the processing proceeds to step S708. If the display region is to be used as the observation field without change, the processing proceeds to step S608. The generation of display image data for normal observation in step S608 will not be described here, as it is the same as that described with reference to the flowchart of FIG. 6.

In step S708, the size of the observation field smaller than that of the display region is set. The size may be set or selected from predetermined values by the user.

In step S709, a value of the mask information acquired in step S701 is referred to for each of the corresponding pixels. Then, a determination is made as to whether the value of the mask information referred to for the corresponding display pixel is 0, in other words, whether the pixel is to be presented at a normal brightness in the attention region, or is to be presented at a lower brightness in the region outside the microscope observation field. The operation in step S709 will not be described in detail, as it is the same as that in step S704.

The operations in step S710 and step S711 will not be described, as they are the same as those in step S705 and step S706, respectively. The only difference is whether the microscope observation field is circular or rectangular in shape.

### (Display Screen Layout)

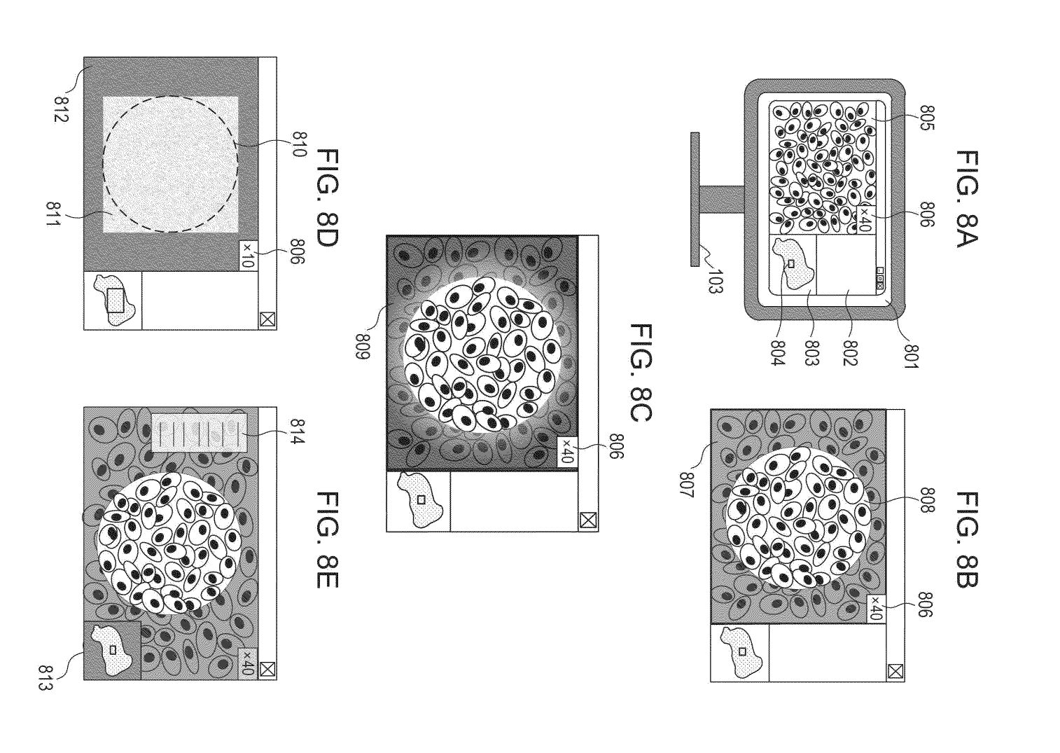

FIGS. 8A to 8E schematically illustrate examples of the display screen of the display apparatus 103 which displays display data generated by the image processing apparatus 102 of the present invention. FIGS. 8A to 8E illustrate the display mode for reproducing a microscope observation field and the high-speed display mode, and how information is presented when the microscope observation field is reproduced.

FIG. 8A is a schematic diagram illustrating a basic configuration of a screen layout of the display apparatus 103. In the display screen of the present embodiment, an entire window 801 includes an information area 802 indicating a display and operation status and information about various images, a specimen thumbnail image 803 to be observed, a detail display region 804 indicating a detailed observation area in the thumbnail image, a display region 805 of specimen image data for detailed observation, and a display magnification 806 of the display region 805. These regions and images may be presented either in a single document interface where the entire window 801 is divided into different functional sections, or in a multiple document interface where the different regions are organized into different windows. The specimen thumbnail image 803 of the present embodiment displays the position and size of the display region 805 of the specimen image data in the entire image of the specimen. The position and size are represented by the frame of the detail display region 804. For example, the detail display region 804 may be directly set by a user's instruction from an externally connected input device, such as the touch panel or the mouse 411. Alternately, the detail display region 804 may be set or updated by moving the display region of the displayed image or by performing a zoom-in or zoom-out operation on the displayed image. The display region 805 for the specimen image data displays specimen image data for detailed observation. In accordance with an operation instruction from the user, the display region is moved (i.e., a region to be observed is selected from the entire specimen image and moved), or an image magnified or reduced by changing the display magnification is displayed.

FIG. 8B illustrates a display screen where a microscope field is reproduced and the brightness of a region outside the microscope field is uniformly lowered. Reference numeral 806 denotes a display magnification. In this example, the display magnification is 40, which is high. Reference numeral 808 denotes an observation region where a microscope field is reproduced and the image is displayed at a normal brightness within the circular field. Reference numeral 807 denotes a non-microscope field region (i.e., a region outside the microscope field) where the brightness is lowered uniformly.

FIG. 8C illustrates a display screen where a microscope field is reproduced and the brightness of a region outside the microscope field is lowered in accordance with a distance from the center of the microscope field. Reference numeral 809 denotes a non-microscope field region (i.e., a region outside the microscope field) where the brightness is gradually lowered in accordance with a distance from the center of the circular region where the microscope field is reproduced. The generation of such a display image will be described in a second embodiment.

FIG. 8D illustrates a microscope field modified when the display screen is updated (or scrolled). In this example, a rectangular region of the same size as the microscope field is presented as an observation field and the brightness of the other region is lowered. Reference numeral 810 denotes a microscope observation field at a standstill. Reference numeral 811 denotes an observation field modified as the screen is updated. In this example, the observation field 811 is sized to include the microscope observation field 810. Reference numeral 812 denotes a non-observation field (i.e., a region outside the observation field) where the brightness is lowered uniformly. As described with reference to FIG. 8C, the brightness may be gradually lowered in accordance with a distance from the center of the microscope observation field.

FIG. 8E illustrates a display screen where various information is presented outside a microscope field. Since the attention region is the microscope observation region, a region outside the microscope observation region may provide an observation image with a lower brightness, specimen information necessary for diagnosis, patient information, and a menu screen. Reference numeral 813 denotes an area for presenting the thumbnail image 803 showing an entire image of the specimen. Reference numeral 814 denotes an information area corresponding to the information area 802. Since the aspect ratio of the display is not square, various information can be displayed outside the circular region (microscope field). Thus, much information can be effectively presented and improved user-friendliness is achieved.

### (Effect of Present Embodiment)

By providing an observation region in a virtual slide image, an image processing apparatus that reduces the burden on the observer can be realized. Particularly in the present embodiment, where the observation field is modified to a rectangular shape during screen scrolling which requires high-speed display, it is possible to improve the processing efficiency. Moreover, unlike a microscope, it is possible to present images and various information outside the observation field region (circular region) to be paid attention to. This makes it easier to find a lesion, and improves user-friendliness.

### Second Embodiment

An image processing system according to a second embodiment of the present invention will now be described with reference to the drawings.

In the first embodiment, the reproduction of a microscope observation field is done by selective processing using multivalued mask information, that is, by adoption of image data and lowering of brightness through bit shifting. Although multivalued mask information is also used in the second embodiment, the equivalent field reproduction is achieved by multiplying the brightness of image data by the mask information, without performing different processing depending on the region. The configurations described in the first embodiment can be used in the second embodiment, except for some configurations different from those in the first embodiment.

### (Apparatus Configuration of Image Processing System)

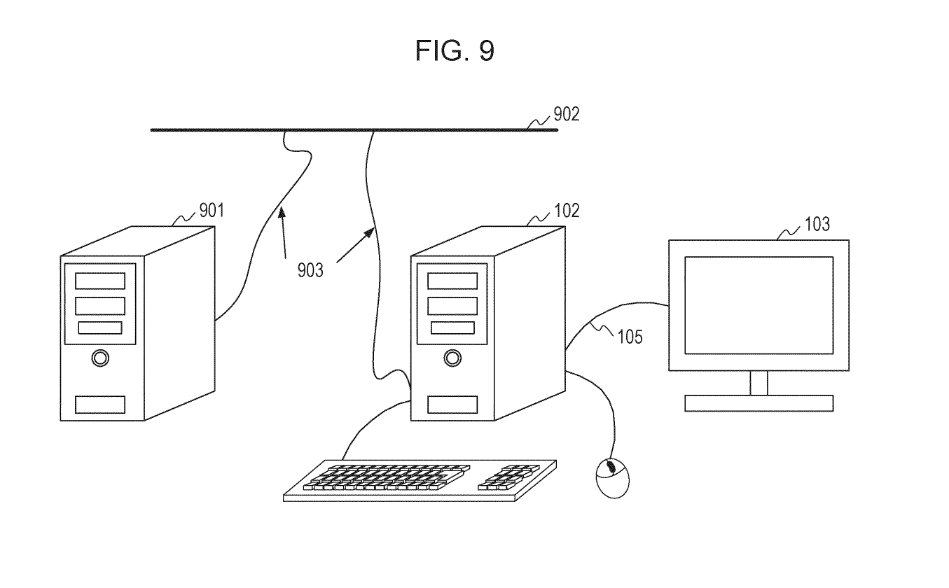

FIG. 9 is a schematic overall view illustrating apparatuses that form the image processing system according to the second embodiment of the present invention.

The image processing system using an image processing apparatus illustrated in FIG. 9 includes an image server 901, the image processing apparatus 102, and the display apparatus 103. The image processing apparatus 102 of the present embodiment can acquire image data of a picked-up image of a specimen from the image server 901, and generate image data for display on the display apparatus 103. In the present embodiment, the image server 901 and the image processing apparatus 102 are connected to each other via a network 902 by general-purpose I/F LAN cables 903. The image server 901 of the present embodiment is a computer having a large-capacity storage device that stores image data of images picked up by the image pickup apparatus 101, which is a virtual slide apparatus. The image server 901 of the present embodiment may store hierarchical image data of different display magnifications as a group in a local storage connected to the image server 901, or may divide the hierarchical image data into segments, each having a data entity and link information, and store them in a server group (cloud server) located somewhere on the network. The hierarchical image data itself does not even have to be stored in a single server. Note that the image processing apparatus 102 and the display apparatus 103 are the same as those in the image processing system of the first embodiment.

In the example of FIG. 9, the image processing system is formed by three apparatuses, the image server 901, the image processing apparatus 102, and the display apparatus 103. However, the present invention is not limited to this configuration. For example, the display apparatus 103 may be an integral part of the image processing apparatus 102, or some functions of the image processing apparatus 102 may be incorporated in the image server 901. Conversely, the functions of the image server 901 or the image processing apparatus 102 may be divided to be realized by a plurality of apparatuses.

### (Generation of Microscope Field Display Image Data)

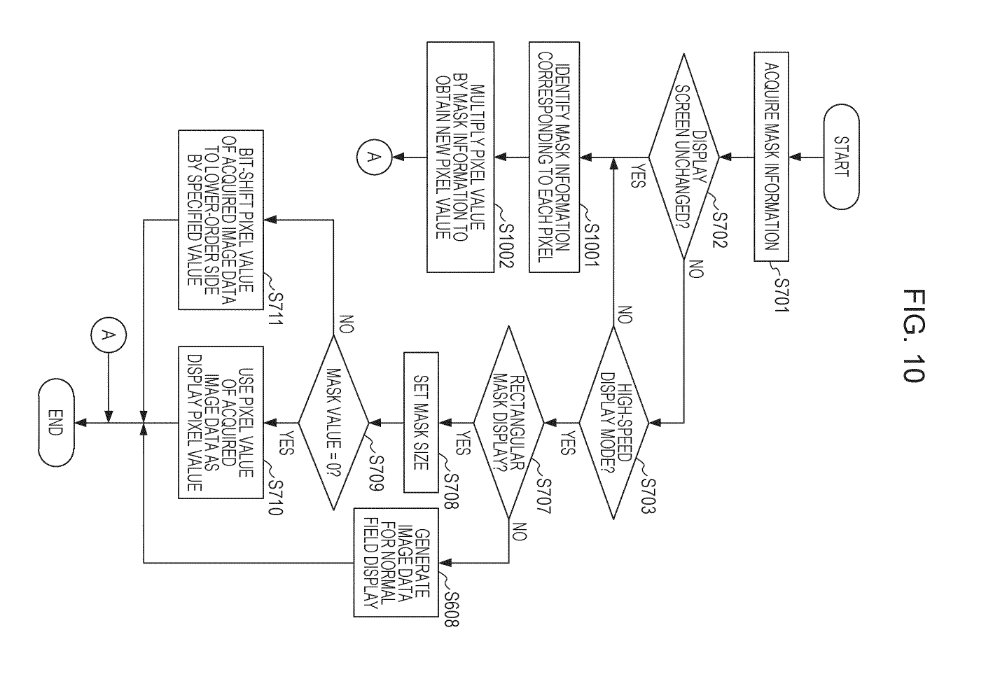

The generation of microscope field display image data according to the first embodiment has been described with reference to FIG. 7. FIG. 10 is a flowchart illustrating a flow of processing in which a field is reproduced by multiplying the brightness of image data by mask information without performing different processing depending on the region, which is a feature of the present embodiment. The processing illustrated in FIG. 10 is the same as that illustrated in FIG. 7, except for the generation of display image data based on the mask information. The description of the same processing will thus be omitted here.

The acquisition of mask information and the branching operations in step S701 to step S703 are the same as those described in the first embodiment with reference to FIG. 7.

In step S1001, mask information corresponding to each pixel of image data is identified. For example, the mask information is 8-bit information, ranging from 0 to 255.

In step S1002, the brightness value of the pixel is multiplied by the value of the corresponding mask information to obtain a new brightness value. In practice, by normalization with a value obtained by dividing the result of the multiplication by 255, which is the maximum value of the mask information, the same brightness value as that before the division takes place is obtained if the mask information is 255. Thus, by applying the same processing to each pixel, a microscope field can be reproduced as in the first embodiment. As described above, the brightness is lowered by bit shifting in the first embodiment. In the second embodiment, however, the brightness can be obtained by multiplication with mask information, so that the degree of freedom of setting the brightness is increased. The mask information may be a specified value prepared in advance, or may be changed or newly set in accordance with a user's instruction. Therefore, the circular observation field that simulates the microscope field can be flexibly changed to other shapes. Such a flexible change of field shape is also possible in the first embodiment.

The processing from step S707, where a determination as to the rectangular mask display in the high-speed display mode is made, to step S711 will not be described, as it is the same as that in the first embodiment.

### (Effect of Present Embodiment)

By providing an observation region in a virtual slide image, an image processing apparatus that reduces the burden on the observer can be realized. In particular, by using the same processing on both the inside and outside of an observation field to generate a display image, it is possible to eliminate the corresponding determination branch and reduce the burden of software processing. Since smooth gradation expression is achieved in the lowering of the brightness, it is possible to further reduce the burden on the user.

### Other Embodiments

The object of the present invention may be achieved by the following. A recording medium (or storage medium) that records program code of software for realizing all or some of the functions of the embodiments described above is supplied to a system or an apparatus. Then, a computer (or CPU or MPU) of the system or apparatus reads and executes the program code stored in the recording medium. In this case, the program code read from the recording medium realizes the functions of the embodiments described above, and the recording medium that records the program code constitutes the present invention.

When the computer executes the read program code, an operating system (OS) or the like running on the computer performs part or all of the actual processing on the basis of instructions in the program code. The configuration in which the functions of the embodiments described above are realized by this processing may also be included in the present invention.

Assume that the program code read from the recording medium is written to a memory included in a function expansion card inserted in the computer or a function expansion unit connected to the computer. Then, a CPU or the like included in the function expansion card or function expansion unit performs part or all of the actual processing on the basis of instructions in the program code. The configuration in which the functions of the embodiments described above are realized by this processing may also be included in the present invention.

When the present invention is applied to the recording medium described above, program code corresponding to the flowcharts described above is stored in the recording medium.

The configurations described in the first and second embodiments may be combined together. For example, the image processing apparatus may be connected to both the image pickup apparatus and the image server, so that an image to be used in processing may be acquired from either the image pickup apparatus or the image server. Configurations obtained by appropriately combining various techniques of the embodiments described above are also within the scope of the present invention.

According to preferred embodiments of the present invention, it is possible to reduce a burden on an observer by displaying an observation region and a non-observation region in different manners.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus that processes a virtual slide image, the image processing apparatus comprising:
an image data acquiring unit configured to acquire image data obtained by picking up an image of an imaging target; and
a display image data generating unit configured to generate display image data from the image data, the display image data including observation region display image data and non-observation region display image data, the observation region display image data being data for displaying on a display apparatus an observation region determined on the basis of a predetermined technique or specified by a user, the non-observation region display image data being data for displaying on the display apparatus a region outside the observation region,
wherein the display image data generating unit performs image processing on at least one of the observation region display image data and the non-observation region display image data to generate the display image data for displaying an image on the display apparatus, the image being different from that obtained when uniform image processing is performed on the entire image data.

2. The image processing apparatus according to claim 1, wherein the display image data generating unit generates the display image data for displaying an observation region that reproduces a microscope field.

3. The image processing apparatus according to claim 2, wherein the display image data generating unit generates the display image data on the basis of existing microscope field information.

4. The image processing apparatus according to claim 3, wherein the display image data generating unit generates the display image data on the basis of the existing microscope field information and magnification information to be displayed as an image.

5. The image processing apparatus according to claim 3, wherein the display image data generating unit generates the display image data by using a predetermined one of a plurality of pieces of existing microscope field information as initial information.

6. The image processing apparatus according to claim 3, wherein the display image data generating unit generates the display image data by using one of a plurality of pieces of existing microscope field information on the basis of a user's selection.

7. The image processing apparatus according to claim 1, wherein the display image data generating unit generates the display image data such that a brightness of the non-observation region is lower than a brightness of the observation region.

8. The image processing apparatus according to claim 1, wherein the display image data generating unit generates the display image data by multiplying the image data by multivalued mask information for each pixel.

9. The image processing apparatus according to claim 1, wherein the display image data generating unit generates the display image data by performing computing on the image data on the basis of mask information indicating two processing forms.

10. The image processing apparatus according to claim 9, wherein the image data is color image data having RGB color information; and
the display image data generating unit converts the image data to brightness color difference data, and performs the computing on a brightness value obtained by the conversion.

11. The image processing apparatus according to claim 9, wherein the mask information indicating two processing forms represents a position at which the image data is to be adopted and a position at which the image data is to be subjected to bit shifting.

12. The image processing apparatus according to claim 11, wherein the amount of bit shifting is changed by an instruction externally input.

13. The image processing apparatus according to claim 11, wherein the display image data generating unit generates the display image data for displaying a circular observation region that simulates a microscope field; and
the amount of bit shifting is changed in accordance with a distance from the center of the circular observation region.

14. The image processing apparatus according to claim 1, wherein while a position or a display magnification of an image to be displayed on the display apparatus is being changed, the display image data generating unit generates display image data that does not distinguish the observation region from the non-observation region.

15. The image processing apparatus according to claim 1, wherein the non-observation region display image data contains information about the imaging target.

16. An image processing method for processing a virtual slide image, the image processing method comprising:
an image data acquiring step of acquiring image data obtained by picking up an image of an imaging target; and
a display image data generating step of generating display image data from the image data acquired in the image data acquiring step, the display image data including observation region display image data and non-observation region display image data, the observation region display image data being data for displaying on a display apparatus an observation region determined on the basis of a predetermined technique or specified by a user, the non-observation region display image data being data for displaying on the display apparatus a region outside the observation region,
wherein the display image data generating step is a step of performing image processing on at least one of the observation region display image data and the non-observation region display image data to generate the display image data for displaying an image on the display apparatus, the image being different from that obtained when uniform image processing is performed on the entire image data.

17. An image processing method for processing a virtual slide image, the image processing method comprising:
an image data acquiring step of acquiring image data obtained by picking up an image of an imaging target; and
a display image data generating step of generating display image data from the image data acquired in the image data acquiring step, the display image data including observation region display image data and non-observation region display image data, the observation region display image data being data for displaying on a display apparatus an observation region determined on the basis of a predetermined technique or specified by a user, the non-observation region display image data being data for displaying on the display apparatus a region outside the observation region,
wherein the display image data generating step is a step of performing image processing on at least one of the observation region display image data and the non-observation region display image data to generate first display image data and second display image data, the first display image data being data for displaying on the display apparatus an image different from that obtained when uniform image processing is performed on the entire image data, the second display image data being data obtained when no image processing is performed on the image data or when uniform image processing is performed on the entire image data,
the image processing method further comprising a display image data transmitting step of transmitting the first display image data to the display apparatus while a position or a display magnification of an image to be displayed on the display apparatus is being changed, and transmitting the second display image data to the display apparatus while a position or a display magnification of an image to be displayed on the display apparatus is not being changed.

18. An image processing system comprising:
the image processing apparatus according to claim 1; and
a display apparatus configured to display a virtual slide image processed by the image processing apparatus in a mode having an observation region that reproduces a microscope field.

19. A program causing a computer to execute each step of the image processing method according to claim 16.

20. A program causing a computer to execute each step of the image processing method according to claim 17.
